(19) United States
(12) Patent Application Publication
(10) Pub. No.: US 2008/0147732 A1
(43) Pub. Date: Jun. 19, 2008

(54) Vital hierarchy of data on diseases

(76) Inventor: Anuthep Benja-Athon, New York, NY (US)

Correspondence Address: ANUTHEP BENJA-ATHON, M.D.;Pain Management, Acupuncture Physical Therapy, 210 E 36th St., New York, NY, 10016, US

(21) Appl. No.: 11/637,662

(22) Filed: Dec. 13, 2006

(51) Int. Cl. G06F 17/30

(52) U.S. Cl. 707/104.1; 707/E17.044

(57) ABSTRACT

A system for generating extensive data on diseases which is organized into a hierarchy or hierarchies of categories based on diseased organ systems, diseases or illnesses affecting or relating to the diseased organ systems and attributes of each disease or illness affecting or relating to the diseased organ systems. Key words, terms and/or sentences in each categories are used as a label, mark or tag for uniquely identify each category and are used for linking and connecting to related category, categories, topics and contents in other categories.

### FIELD OF INVENTION

A system of generating useful data on diseases

### BACKGROUND OF THE INVENTION

There existed heretofore no system which provided or yielded comprehensive, vital and useful information on diseases so that any person wanting to know as much as possible about a disease, disorder or illness affecting a human or humans were unable to achieve.

Prior art on medicine, surgery and health is analogous to an artificial 2-dimensional view of same.

This is because there was heretofore no know-how and, therefore, means for achieving and providing the system and method of the present invention.

Consequently, the health, well-being and socioeconomics of people are adversely affected, much avoidable medical errors are resulted and many lives are lost each year.

### OBJECTIVES OF THE INVENTION

The present invention uses the expertises, knowledge and inputs of physicians to generate, create, maintain and propagate the most comprehensive data on diseases, disorders and illnesses.

The present invention provides a system or organization of hierarchy or hierarchies of categories of diseased organ systems, diseases or illnesses affecting or relating to diseased organ systems and attributes of each disease or illness affecting or relating to said diseased organ systems wherein data on said systems, diseases, illnesses and attributes are generated and retrieved for display on a means for displaying said data. Furthermore, the present invention provides the facilitation for physicians to generate, create, maintain and propagate the most comprehensive data on diseases, disorders and illnesses.

The health, well-being, safety and socioeconomic impacts on all humans are immense.

### SUMMARY OF THE INVENTION

Prior art cannot and do not provide comprehensive and vital information on diseases, disorders and illnesses affecting humans.

The present invention is a system for generating extensive, comprehensive and useful data on diseases, disorders and illnesses which are organized into a hierarchy or hierarchies of categories based on diseased organ systems, diseases or illnesses affecting or relating to the diseased organ systems and attributes of each disease or illness affecting or relating to the diseased organ systems. Key words, terms and/or sentences in each categories are used as a label, mark or tag for uniquely identify each category and are used for linking and connecting to related category, categories, topics and contents in other categories.

### DESCRIPTION OF THE PREFERRED EMBODIMENTS

The present invention, first, is a system of hierarchy of categories of diseased organ systems, diseases or illnesses affecting or relating to diseased organ systems and attributes of each disease or illness affecting or relating to said diseased organ systems wherein data on said systems, diseases, illnesses and attributes are generated and retrieved for display on a means for displaying said data.

In addition, second, the present invention provides a system of words for labeling, marking or distinguishing individual categories in a system of hierarchy of categories of diseased organ systems, diseases or illnesses affecting or relating to diseased organ systems and attributes of each disease or illness affecting or relating to said diseased organ systems wherein data on said systems, diseases, illnesses and attributes. Said system of words comprises individual groups of key words each of which is generated, marked and stored and wherein each group of key words endows individual unique identity to each category in said hierarchy of individual categories to be used to produce outcomes and results to achieve the goals and objectives of the present invention.

In addition, third, the present invention also provides a system of word means for linking categories comprising diseased organ systems, diseases or illnesses affecting or relating to said diseased organ systems and attributes of each disease or illness affecting or relating to said diseased organ systems of a hierarchy of categories wherein key words, terms, phrases, sentences, concepts, fundamentals in individual categories are linked to related categories and are linked to relating topics, contents, organ systems, diseases, illnesses, disorders, concepts or fundamentals in other categories in said system of hierarchy or hierarchies. Thus, physicians and experts using the above networking or networkings of said key words, terms, phrases, sentences produce a network or networks of linked, related or associated data in said hierarchy or hierarchies of data and information adaptable to be used to produce outcomes and results to achieve the goals and objectives of the present invention.

The attributes, characteristics, property or description of a disease, disorder or illness affecting humans pertain to the practices of medicine and surgery by physicians are represented by an “*” infra which also encompass anatomy, neuroanatomy, physiology, pathology, neuropathology, neurology, neurophysiology, neuroanatomy, microscopic anatomy, embryology, immunology, microbiology, virology, parasitology and all items infra and related information and data relating to a diseased organ system and diseases or illnesses, etc. where applicable.

A representation of one of the preferred embodiments of the present invention is as follows:

### RheumatologyArthropathyOsteoarthritis—* or

### RheumatologyArthropathyOsteoarthritis—Definition

### RheumatologyArthropathyOsteoarthritis—Anatomy

### RheumatologyArthropathyOsteoarthritis—Etiology

### RheumatologyArthropathyOsteoarthritis—Epidemiology

### RheumatologyArthropathyOsteoarthritis—Pathogenesis

### RheumatologyArthropathyOsteoarthritis—Immunopathogenesis

### RheumatologyArthropathyOsteoarthritis—Pathophysiology

### RheumatologyArthropathyOsteoarthritis—Neuropathology

### RheumatologyArthropathyOsteoarthritis—Organisms

### RheumatologyArthropathyOsteoarthritis—Genetics

### RheumatologyArthropathyOsteoarthritis—Chief complaints

### RheumatologyArthropathyOsteoarthritis—Symptoms, signs and manifestations

### RheumatologyArthropathyOsteoarthritis—Figures, diagrams, tables and illustrations

### RheumatologyArthropathyOsteoarthritis—Clinical course and progression

### RheumatologyArthropathyOsteoarthritis—Laboratory diagnosis

### RheumatologyArthropathyOsteoarthritis—Tests

### RheumatologyArthropathyOsteoarthritis—Imaging

### RheumatologyArthropathyOsteoarthritis—Biopsy

### RheumatologyArthropathyOsteoarthritis—Laboratory

### RheumatologyArthropathyOsteoarthritis—Medical treatments

### RheumatologyArthropathyOsteoarthritis—Surgical treatments

### RheumatologyArthropathyOsteoarthritis—Medications

### RheumatologyArthropathyOsteoarthritis—Sequalae

### RheumatologyArthropathyOsteoarthritis—Management

### RheumatologyArthropathyOsteoarthritis—Prevention

### RheumatologyArthropathyGoutyArthritis—Immunization

### RheumatologyArthropathyOsteoarthritis—Authors

### RheumatologyArthropathyOsteoarthritis—EmailAddresses

### RheumatologyArthropathyOsteoarthritis—Reference and bibliography

### RheumatologyArthropathyGoutyArthritis—* or

### RheumatologyArthropathyGoutyArthritis—Definition

### RheumatologyArthropathyGoutyArthritis—Anatomy

### RheumatologyArthropathyGoutyArthritis—Etiology

### RheumatologyArthropathyGoutyArthritis—Epidemiology

### RheumatologyArthropathyGoutyArthritis—Pathogenesis

### RheumatologyArthropathyGoutyArthritis—Immunopathogenesis

### RheumatologyArthropathyGoutyArthritis—Pathophysiology

### RheumatologyArthropathyGoutyArthritis—Neuropathology

### RheumatologyArthropathyGoutyArthritis—Organisms

### RheumatologyArthropathyGoutyArthritis—Genetics

### RheumatologyArthropathyGoutyArthritis—Chief complaints

### RheumatologyArthropathyGoutyArthritis—Symptoms, signs and manifestations

### RheumatologyArthropathyGoutyArthritis—Figures, diagrams, tables and illustrations

### RheumatologyArthropathyGoutyArthritis—Clinical course and progression

### RheumatologyArthropathyGoutyArthritis—Laboratory diagnosis

### RheumatologyArthropathyGoutyArthritis—Tests

### RheumatologyArthropathyGoutyArthritis—Imaging

### RheumatologyArthropathyGoutyArthritis—Biopsy

### RheumatologyArthropathyGoutyArthritis—Laboratory

### RheumatologyArthropathyGoutyArthritis—Medical treatments

### RheumatologyArthropathyGoutyArthritis—Surgical treatments

### RheumatologyArthropathyGoutyArthritis—Medications

### RheumatologyArthropathyGoutyArthritis—Sequalae

### RheumatologyArthropathyGoutyArthritis—Management

### RheumatologyArthropathyGoutyArthritis—Prevention

### RheumatologyArthropathyGoutyArthritis—Immunization

### RheumatologyArthropathyGoutyArthritis—Authors

### RheumatologyArthropathyGoutyArthritis—EmailAddresses

### RheumatologyArthropathyGoutyArthritis—Reference and bibliography

Another representation of one of the preferred embodiments of the present invention is as follows:

### RheumatologySystemicDiseasesSystemicLupusErythematosus—* or

### RheumatologySystemicDiseasesSystemicLupusErythematosus—Definition

### RheumatologySystemicDiseasesLupusErythematosus—Anatomy

### RheumatologySystemicDiseasesSystemicLupusErythematosus—Etiology

### RheumatologySystemicDiseasesSystemicLupusErythematosus—Epidemiology

### RheumatologySystemicDiseasesSystemicLupusErythematosus—Pathogenesis

### RheumatologySystemicDiseasesSystemicLupusErythematosus—Immunopathogenesis

### RheumatologySystemicDiseasesSystemicLupusErythematosus—Pathophysiology

### RheumatologySystemicDiseasesSystemicLupusErythematosus—Neuropathology

### RheumatologySystemicDiseasesSystemicLupusErythematosus—Organisms

### RheumatologySystemicDiseasesSystemicLupusErythematosus—Genetics

### RheumatologySystemicDiseasesSystemicLupusErythematosus—Chief complaints

### RheumatologySystemicDiseasesLupusErythematosus—Symptoms, signs & manifestations

### RheumatologyAutoimmunologySystemicLupusErythematosus—Figures, diagrams, tables and illustrations

### RheumatologySystemicDiseasesSystemicLupusErythematosus—Clinical course and progression

### RheumatologySystemicDiseasesSystemicLupusErythematosus—Laboratory diagnosis

### RheumatologySystemicDiseasesSystemicLupusErythematosus—Tests

### RheumatologySystemicDiseasesSystemicLupusErythematosus—Imaging

### RheumatologySystemicDiseasesSystemicLupusErythematosus—Biopsy

### RheumatologySystemicDiseasesSystemicLupusErythematosus—Laboratory

### RheumatologySystemicDiseasesSystemicLupusErythematosus—Medical treatments

### RheumatologySystemicDiseasesSystemicLupusErythematosus—Surgical treatments

### RheumatologySystemicDiseasesSystemicLupusErythematosus—Medications

### RheumatologySystemicDiseasesSystemicLupusErythematosus—Sequalae

### RheumatologySystemicDiseasesSystemicLupusErythematosus—Management

### RheumatologySystemicDiseasesSystemicLupusErythematosus—Prevention

### RheumatologySystemicDiseasesSystemicLupusErythematosus—Immunization

### RheumatologySystemicDiseasesSystemicLupusErythematosus—Authors

### RheumatologySystemicDiseasesSystemicLupusErythematosus—EmailAddresses

### RheumatologySystemicDiseasesSystemicLupusErythematosus—Reference and bibliography

### RheumatologySystemicDiseasesSjögrenSyndrome—* or

### RheumatologySystemicDiseasesSjögrenSyndrome—Definition

### RheumatologySystemicDiseasesSjögrenSyndrome—Anatomy

### RheumatologySystemicDiseasesSjögrenSyndrome—Etiology

### RheumatologySystemicDiseasesSjögrenSyndrome—Epidemiology

### RheumatologySystemicDiseasesSjögrenSyndrome—Pathogenesis

### RheumatologySystemicDiseasesSjögrenSyndrome—Immunopathogenesis

### RheumatologySystemicDiseasesSjögrenSyndrome—Pathophysiology

### RheumatologySystemicDiseasesSjögrenSyndrome—Neuropathology

### RheumatologySystemicDiseasesSjögrenSyndrome—Organisms

### RheumatologySystemicDiseasesSjögrenSyndrome—Genetics

### RheumatologySystemicDiseasesSjögrenSyndrome—Chief complaints

### RheumatologySystemicDiseasesSjögrenSyndrome—Symptoms, signs and manifestations

### RheumatologySystemicDiseasesSjögrenSyndrome—Figures, diagrams, tables and illustrations

### RheumatologySystemicDiseasesSjögrenSyndrome—Clinical course and progression

### RheumatologySystemicDiseasesSjögrenSyndrome—Laboratory diagnosis

### RheumatologySystemicDiseasesSjögrenSyndrome—Tests

### RheumatologySystemicDiseasesSjögrenSyndrome—Imaging

### RheumatologySystemicDiseasesSjögrenSyndrome—Biopsy

### RheumatologySystemicDiseasesSjögrenSyndrome—Laboratory

### RheumatologySystemicDiseasesSjögrenSyndrome—Medical treatments

### RheumatologySystemicDiseasesSjögrenSyndrome—Surgical treatments

### RheumatologySystemicDiseasesSjögrenSyndrome—Medications

### RheumatologySystemicDiseasesSjögrenSyndrome—Sequalae

### RheumatologySystemicDiseasesSjögrenSyndrome—Management

### RheumatologySystemicDiseasesSjögrenSyndrome—Prevention

### RheumatologySystemicDiseasesSjögrenSyndrome—Immunization

### RheumatologySystemicDiseasesSjögrenSyndrome—Authors

### RheumatologySystemicDiseasesSjögrenSyndrome—EmailAddresses

### RheumatologySystemicDiseasesSjögrenSyndrome—Reference and bibliography

In brief, said words “SystemicLupusErythematosus” or “SjögrenSyndrome” are substituted with words describing or representing diseases, disorders or illnesses in said diseased organ system—Systemic Diseases—with other related diseased organ systems such as Polymyalgia Rheumatica, Temporal Arteritis, Churg-Strauss Syndrome and Wegener Granulomatosus.

Yet another representation of one of the preferred embodiments of the present invention is as follows:

### NeurologyFacialNerveDisordersBell'sPalsy—* or

### NeurologyFacialNerveDisordersBell'sPalsy—Definition

### NeurologyFacialNerveDisordersBell'sPalsy—Anatomy

### NeurologyFacialNerveDisordersBell'sPalsy—Etiology

### NeurologyFacialNerveDisordersBell'sPalsy—Epidemiology

### NeurologyFacialNerveDisordersBell'sPalsy—Pathogenesis

### NeurologyFacialNerveDisordersBell'sPalsy—Immunopathogenesis

### NeurologyFacialNerveDisordersBell'sPalsy—Pathophysiology

### NeurologyFacialNerveDisordersBell'sPalsy—Neuropathology

### NeurologyFacialNerveDisordersBell'sPalsy—Organisms

### NeurologyFacialNerveDisordersBell'sPalsy—Genetics

### NeurologyFacialNerveDisordersBell'sPalsy—Chief complaints

### NeurologyFacialNerveDisordersBell'sPalsy—Symptoms, signs and manifestations

### NeurologyFacialNerveDisordersBell'sPalsy—Figures, diagrams, tables and illustrations

### NeurologyFacialNerveDisordersBell'sPalsy—Clinical course and progression

### NeurologyFacialNerveDisordersBell'sPalsy—Laboratory diagnosis

### NeurologyFacialNerveDisordersBell'sPalsy—Tests

### NeurologyFacialNerveDisordersBell'sPalsy—Imaging

### NeurologyFacialNerveDisordersBell'sPalsy—Biopsy

### NeurologyFacialNerveDisordersBell'sPalsy—Laboratory

### NeurologyFacialNerveDisordersBell'sPalsy—Medical treatments

### NeurologyFacialNerveDisordersBell'sPalsy—Surgical treatments

### NeurologyFacialNerveDisordersBell'sPalsy—Medications

### NeurologyFacialNerveDisordersBell'sPalsy—Sequalae

### NeurologyFacialNerveDisordersBell'sPalsy—Management

### NeurologyFacialNerveDisordersBell'sPalsy—Prevention

### NeurologyFacialNerveDisordersBell'sPalsy—Immunization

### NeurologyFacialNerveDisordersBell'sPalsy—Authors

### NeurologyFacialNerveDisordersBell'sPalsy—EmailAddresses

### NeurologyFacialNerveDisordersBell'sPalsy—Reference and bibliography

In brief, in said representation, said words representing disease “Bell'sPalsy” or “Bell's Palsy” are substituted with other words relating to facial nerve disorders—diseased organ system—such as, but not limited to, sarcoidosis, Guillain-Barré syndrome, leprosy, leukemia and menigococcal meningitis.

Data and said format of data on diseases, illnesses and disorders associate with, relate to or within about 80 medical and surgical specialties such as, but not limited to, rheumatology and neurology as shown and applied supra, pediatrics, endocrinology, internal medicine, cardiology, etc., are subjected to above according to the spirit and claims of the present invention to achieve the goals and objectives of the present invention.

It is further understood that although the applications of a list of 80 medical and surgical specialties such as, but not limited to, rheumatology and neurology as shown and applied supra, pediatrics, endocrinology, internal medicine, cardiology, infectious diseases, orthopaedic surgery, etc., representing one of the preferred embodiments of the present invention can and will be used to either fine tune or optimize the versatility of the applications and outcomes of the present invention to achieve the goals and objectives of the present invention.

Therefore, there are about 80 medical and surgical specialties, practices or fields. Furthermore, guessing a number about few thousands of subjects, topics or identifications on diseased organ systems of humans such as, but not limited, arthropathy or arthropathies, systemic diseases, facial nerve disorders, neuropathy or neuropathies, nerve tunnel syndrome or syndromes, myopathy or myopathies and said number of attributes per diseased organ system represent by “*” supra. Based on the above approximate numbers, therefore, empirically picking a number of 1,000 diseased organ systems×about 29 attributes per each diseased organ system=29,000 categories. Therefore, participating physicians—number in a few hundred thousands to several hundred thousands—can and will use the present invention to generate and store data and information on diseases, disorders and illnesses according to the teaching of the present invention.

First example, rheumatologists—number in tens to thousands—on arthropathies access and use a hierarchy of categories comprising RheumatologyArthropathyOsteoarthritis—* to fulfill the objectives and goals and related of the present invention. In other words, said rheumatologists enter data on arthropathy and osteoarthritis into individual categories.

Second example, neurologists—number in tens to thousands—on facial nerve disorders access and use a hierarchy of categories comprising NeurologyFacialNerveDisordersBell'sPalsy—* to fulfill the objectives and goals and related of the present invention. In other words, said neurologists enter data on facial nerve disorders and Bell's palsy into individual categories.

Third example, cardiologists—number in tens to thousands—on coronary artery diseases (not used supra) access and use a hierarchy of categories comprising Cardiology CoronaryArteryDiseases MyocardialInfarction—* to fulfill the objectives and goals and related of the present invention. In other words, said cardiologists enter data on coronary artery diseases and myocardial infarction into individual categories.

Fourth example, infectious disease physicians—number in tens to thousands—on gram-negative bacterias (not used supra) access and use a hierarchy of categories comprising InfectiousDiseasesGramNegativeBacteriasTyphoid—* to fulfill the objectives and goals and related of the present invention. In other words, said infectious disease physicians enter data on grain-negative bacterias and typhoid into individual categories.

In addition, the present invention also provides a system of word means for linking categories comprising diseased organ systems, diseases or illnesses affecting or relating to said diseased organ systems and attributes of each disease or illness affecting or relating to said diseased organ systems of a hierarchy of categories wherein key words in individual categories are linked to relating categories or are linked to relating topics or contents in other categories to be used by physicians and experts to produce a hierarchy or hierarchies of linked data in said hierarchy or hierarchies of data and information adaptable to be used to produce outcomes and results to achieve the goals and objectives of the present invention. In other words, key words, Meta Tag or Meta Name of each said category comprising key component words in each said category are generated and posted to each said category—a unique tag or identification of each category in said system—is one of the preferred embodiments of the present invention.

First example, using a category supra—RheumatologyArthropathyGoutyArthritis—Definition, a group of key words among choices of groups of key words representing one of the preferred embodiments assigned, posted or tagged to this category is “gout joint”.

Second example, using a category supra—NeurologyFacialNerveDisordersBell'sPalsy—Etiology, a group of key words among choices of groups of key words representing one of the preferred embodiments assigned, posted or tagged to this category is “Facial weakness infections cardiovascular causes”.

In addition, third, the present invention also provides a system of word means for linking categories comprising diseased organ systems, diseases or illnesses affecting or relating to said diseased organ systems and attributes of each disease or illness affecting or relating to said diseased organ systems of a hierarchy of categories wherein key words, terms, phrases, sentences, concepts, fundamentals in individual categories are linked to related categories and are linked to related topics, contents, organ systems, diseases, illnesses, disorders, concepts or fundamentals in other categories in said system of hierarchy or hierarchies. Thus, physicians and experts using the above networking or networkings of said key words, terms, phrases, sentences produce a network or networks of linked, related or associated data in said hierarchy or hierarchies of data and information adaptable to be used to produce outcomes and results to achieve the goals and objectives of the present invention.

Therefore, the present invention provides means for showing links for linking to related categories and/or related topics, contents, organ systems, diseases, illnesses, disorders, concepts or fundamentals in other categories in said system of hierarchy or hierarchies and means for availing links for connecting to related categories and/or related topics, contents, organ systems, diseases, illnesses, disorders, concepts or fundamentals in other categories in said system of hierarchy or hierarchies. A few of preferred embodiments of the present invention are such as, but not limited to, arrangements, orders and/or panel means. Taking said panel means as an example, said means for showing links are either seen and fixed to one or multiple locations on said means for displaying or are associated with a word, term, group of words, phrase, sentence, image, figure, concept, fundamental or words, terms, phrases, sentences, groups of words, images, figures, concepts, fundamentals in each of said categories or are present as pop-ups comprising related categories and/or related topics, contents, organ systems, diseases, illnesses, disorders, images, figures, concepts or fundamentals in other categories in said system of hierarchy or hierarchies in each of said categories on said means for displaying. Based on the preferred embodiments supra, by pointing and clicking a word, term, group of words, phrase, sentence, image, figure, concept, fundamental or words, terms, phrases, sentences, groups of words, images, figures, concepts, fundamentals in said panel means, physicians and experts views and uses said features and linkages to generate and create extensive network or networks of data on diseases, disorders and illnesses.

It is to be understood that although the lack of the use of spaces between words supra as one of the preferred embodiments of the present invention, the use or not use of spaces between words does not interfere with the spirit and the scope of the claims of the present invention. In other words, the practice of the preferred embodiments of the present invention may or may not apply spaces between words. In other words, a set of words has the same meaning herein such as, but not limited to, Systemic Lupus Erythematosus=SystemicLupusErythematosus, Bell'sPalsy=Bell's palsy, etc.

Adaptations, editions and improvements of the preferred embodiments of the present invention can be done or achieved to fulfill the objectives and goals of the present invention within the spirit and scope of the present invention.

Although various preferred embodiments of the present invention have been described for humans, it will be appreciated by those skilled in the art that the present invention can and will be used for other animal and plant species without departing from the spirit of the invention and the scope of the claims.

Although various preferred embodiments of the present invention have been described, it will be appreciated by those skilled in the art that adaptations and variations may be made without departing from the spirit of the invention and the scope of the claims.

1. A hierarchy of categories of diseased organ systems, diseases or illnesses affecting or relating to said diseased organ systems and attributes of each disease or illness affecting or relating to said diseased organ systems wherein data on or relate to said systems, diseases, illnesses and attributes are generated and retrieved for display on a means for displaying said data comprises:
identities of diseased organ systems;
descriptions of diseases affecting an organ system;
descriptions of illnesses affecting an organ system;
word means for organizing information on diseases;
word means for organizing information on illnesses;
word means for linking information on a disease;
word means for linking information on diseases;
word means for linking information on an illness; and
word means for linking information on illnesses.

2. A hierarchy of categories of diseased organ systems, diseases or illnesses affecting or relating to said diseased organ systems and attributes of each disease or illness affecting or relating to said diseased organ systems wherein data on or relate to said systems, diseases, illnesses and attributes are generated and stored, wherein first key words in individual categories are generated, marked and stored and wherein said first key words endow individual unique identities to individual categories and wherein second key words in individual categories are generated, marked and stored and said second key words link related contents in categories and link related categories wherein data on or relate to said systems, diseases, illnesses and attributes are generated and retrieved for display on a means for displaying said data comprises:
identities of diseased organ systems;
descriptions of diseases affecting an organ system;
descriptions of illnesses affecting an organ system;
word means for organizing information on diseases;
word means for organizing information on illnesses;
word means for linking information on a disease;
word means for linking information on diseases;
word means for linking information on an illness;
word means for linking information on illnesses;
word means for labeling information on diseases;
word means for labeling information on illness;
means for showing links; and
means for availing links.

3. A system of word means for linking categories comprising diseased organ systems, diseases or illnesses affecting or relating to said diseased organ systems and attributes of each disease or illness affecting or relating to said diseased organ systems in a system of hierarchy or hierarchies of said categories wherein key words, terms, phrases, sentences in individual categories are linked to relating categories or are linked to relating topics or contents in other categories and wherein said key words, terms, phrases, sentences are means for connecting to said relating categories and relating topics or contents in other categories comprises:
identities of diseased organ systems;
descriptions of diseases affecting an organ system;
descriptions of illnesses affecting an organ system;
word means for organizing information on diseases;
word means for organizing information on illnesses;
word means for linking information on a disease;
word means for linking information on diseases;
word means for linking information on an illness;
word means for linking information on illnesses;
means for showing links; and
means for availing links.

4. The word means for linking categories according to claim 3 comprises key words, terms, phrases, sentences relating to other said categories.

5. The word means for linking categories according to claim 3 comprises key words, terms, phrases, sentences relating to related topics or contents in other said categories.
